(19) United States
(12) Patent Application Publication
(10) Pub. No.: US 2025/0054184 A1
(43) Pub. Date: Feb. 13, 2025

(54) METHOD AND APPARATUS FOR ESTIMATING HEAD ROTATION ANGLE

(71) Applicant: NEC Corporation, Tokyo (JP)

(72) Inventors: Charles Chi Hin CHOY, Singapore (SG); Ni Ni SOE, Singapore (SG)

(73) Assignee: NEC Corporation, Tokyo (JP)

(21) Appl. No.: 18/781,139

(22) Filed: Jul. 23, 2024

(30) Foreign Application Priority Data
Aug. 10, 2023 (SG) 10202302275P

(51) Int. Cl. G06T 7/73; G06T 7/60

(52) U.S. Cl. CPC G06T 7/73; G06T 7/60; G06T 2207/20076; G06T 2207/30201

(57) ABSTRACT

The present disclosure provides a method and an apparatus for estimating a rotation angle of a head of a person using an image comprising a frontal view of the person, the method comprising: calculating a distance between two or more vertically apart points on the head of the person from the image; and estimating a rotation angle of the head of the person based on the distance.

### INCORPORATION BY REFERENCE

This application is based upon and claims the benefit of priority from Singapore patent application No. 10202302275P, filed on Aug. 10, 2023, the disclosure of which is incorporated herein in its entirety by reference.

### TECHNICAL FIELD

The present invention relates broadly, but not exclusively, to a method and an apparatus for estimating a rotation angle of a head of a person using an image.

### BACKGROUND ART

Neck pain is one of the most common musculoskeletal diseases, affecting 222 million people worldwide. The cervical (neck) range of motion (CROM) is a tool used to access the neck's state across three movement axes: (1) flexion/extension, (2) lateral flexion and (3) rotation. In a clinical setting, neck (head) rotation is usually measured by a trained therapist with a goniometer from the top of the subject's head.

Telemedicine is gaining popularity due to its convenience. However, a major challenge of telemedicine is that assessments cannot be done remotely easily and lack sufficient evidence to support the clinician's diagnosis. Most telemedicine settings only use a single camera to capture the subject's video or photo at a horizontal level, e.g., from the frontal or side view.

Capturing the subject's top view with a camera is not feasible as it is difficult to set up at home. Hence, measuring head rotation virtually is challenging.

Therefore, there is a need for a method to measure head rotation using an image input device with simple setup when neck assessment is needed during a telemedicine consultation.

Furthermore, other desirable features and characteristics will become apparent from the subsequent detailed description and the appended claims, taken in conjunction with the accompanying drawings and this background of the disclosure.

### SUMMARY

In a first aspect, the present disclosure provides a method for estimating a rotation angle of a head of a person using an image comprising a frontal view of the person, the method comprising: calculating a distance between two or more vertically apart points on the head of the person from the image; and estimating a rotation angle of the head of the person based on the distance.

In a second aspect, the present disclosure provides an apparatus for estimating a rotation angle of a head of a person using an image comprising a frontal view of the person, the apparatus comprising: at least one processor; and at least one memory including computer program code; the at least one memory and the computer program code configured to, with at least one processor, cause the apparatus at least to: calculate a distance between two or more vertically apart points on the head of the person from the image; and estimate a rotation angle of the head of the person based on the distance.

In a third aspect, the present disclosure provides a system for estimating a rotation angle of a head of a person using an image comprising a frontal view of the person, the system comprises the apparatus of according to the second aspect and an image capturing apparatus for capturing the image comprising the frontal view of the person.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention will be better understood and readily apparent to one of ordinary skill in the art from the following written description, by way of example only, and in conjunction with the drawings, in which:

FIG. 1 shows a schematic diagram illustrating six different cervical motions.

FIG. 2A shows a schematic diagram illustrating a neck rotation angle measured from the top view of a person.

FIG. 2B shows an image of a goniometer.

FIG. 3 shows a block diagram illustrating an apparatus for estimating an angle of rotation of a head of a person from an image comprising a frontal view of the person according to various embodiments of the present disclosure.

FIG. 4 shows a flow chart illustrating a method for estimating a rotation angle of a head of a person according to various embodiments of the present disclosure.

FIG. 5A shows an image of a person's head in its neutral position from a frontal view perspective.

FIG. 5B shows an image of a person's head from the same frontal perspective view after the person performs a head rotation.

FIG. 6 shows a schematic diagram illustrating a radius of rotation and a horizontal displacement of a person's nose tip from the top view when the person performs a head rotation.

FIG. 7 shows a schematic diagram of a frontal view and a side view of a person.

FIG. 8 shows a schematic diagram illustrating the various distances between two points on a person's head from a side view.

FIG. 9 shows another schematic diagram illustrating the various distances between two points on a person's head from a side view.

FIG. 10A shows a reference frame comprising a frontal view of a person where the person's head is in neutral position.

FIG. 10B shows a target frame comprising a frontal view of a person where the person's head is rotated out from its neutral position, respectively.

FIG. 11 shows a diagram illustrating the relationship between a viewing distance and an image plane due to perspective change.

FIG. 12A shows a schematic diagram illustrating a radius of rotation and a horizontal displacement of a person's nose tip measured from the top view.

FIG. 12B shows a schematic diagram illustrating a radius of rotation and a horizontal displacement of a person's nose tip from the top view and from the frontal view, respectively, FIGS. 8 and 9 show schematic diagrams illustrating the various distances between two points on a person's head from a side view.

FIG. 13A shows a frontal view frame illustrating an eyebrow-chin distance when the person's head is in neutral position.

FIG. 13B shows a frontal view frame illustrating an eyebrow-chin distance when the person's head is rotated, respectively.

FIG. 14A shows a 3D model illustrating example FMLs and FLPs according to an embodiment of the present disclosure.

FIG. 14B shows a 3D model illustrating example TMLs, FMLs and FLPs according to an embodiment of the present disclosure.

FIG. 15 shows a block diagram illustrating an apparatus for estimating an angle of rotation of a head of a person from an image comprising a frontal view of the person according to various embodiment of the present disclosure.

FIG. 16 shows a flow chart illustrating an example process for estimating an angle of rotation of a head of a person from an image comprising a frontal view of the person according to an embodiment of the present disclosure.

FIG. 17A shows a first example reference frame used in conventional method for estimating a head rotation angle from the top view.

FIG. 17B shows a first example target frame used in conventional method for estimating a head rotation angle from the top view.

FIG. 18 shows a first example single frame used for estimating a head rotation angle from the frontal view according to an embodiment of the present disclosure.

FIG. 19A shows a second example reference frame used in conventional method for estimating a head rotation angle from the top view.

FIG. 19B shows a second example target frame used in conventional method for estimating a head rotation angle from the top view.

FIG. 20 shows a second example single frame used for estimating a head rotation angle from the frontal view according to an embodiment of the present disclosure.

FIG. 21A shows the 132^{nd} frame of a 200-frame video comprising a frontal view of a person performing a head rotation according to an embodiment.

FIG. 21B shows a table with the rotation angle results measured by a motion sensor at the time when the 123^{rd}-135^{th} frames of the 200-frame video referred to in FIG. 21A were taken.

FIG. 22 shows a first example of implementing a system for estimating a person's head rotation angle from a video comprising a frontal view of the person according to various embodiments of the present disclosure.

FIG. 23 shows a second example of implementing a system for estimating a person's head rotation angle from a video comprising a frontal view of the person according to various embodiments of the present disclosure.

FIG. 24 shows a third example of implementing a system for estimating a person's head rotation angle from a video comprising a frontal view of the person according to various embodiments of the present disclosure.

FIG. 25 shows a fourth example of implementing a system for estimating a person's head rotation angle from a video comprising a frontal view of the person according to various embodiments of the present disclosure.

FIG. 26 shows a schematic diagram of an exemplary computing device suitable for use to execute the method in FIG. 4 and implement the apparatus in FIG. 3.

### EXAMPLE EMBODIMENT

### Terms Description

Frontal view-a frontal view of a person refers to a perspective of a person which head and body faces towards an image capturing apparatus at his/her neutral position. Such view tends towards bilateral symmetry.

Point—a point refers to a landmark, a part or position of a body or head of a person. In various embodiments below, multiple points on the body and/or head are detected from an image to draw a medial trunk line of the person and calculate a displacement of a point from the medial trunk line to estimate a head rotation angle.

Distance—a distance refers to a length of the space between two points and can be measured using the number of pixels span between the two points.

Rotation radius—a rotation radius refers to a distance of a point on the head (typically the person's nose tip) from an axis of head rotation when it moves around the axis. Typically, such axis corresponds to the line of intersection between sagittal plane and coronal plane of a person.

Coefficient—a coefficient refers to a multiplier used to convert a distance between two vertically points on a head of a person measured from a frontal view of the person to a rotation radius of the person.

Reference point—a reference point of a person refers to a point which is used to draw a vertical reference line representing an axis of head rotation from a frontal view of the person. In most cases, a reference point remains relatively unchanged from the frontal view regardless of head rotation angle. Examples of a reference point includes jugular notch or shoulder centre.

### Exemplary Embodiments

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present disclosure relate to a method and an apparatus for estimating an angle of rotation of a head of a person from an image comprising a frontal view of the person.

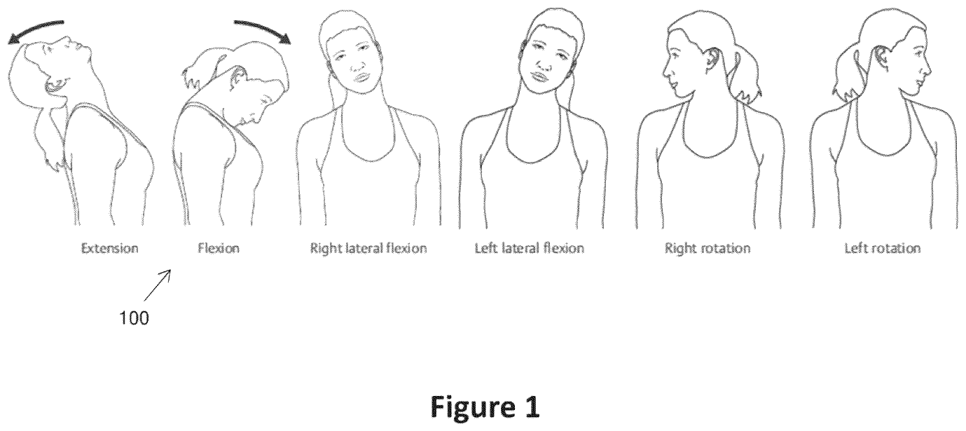

A person can move his/her head by moving his/her neck. FIG. 1 shows a schematic diagram 100 illustrating six different cervical motions. A person's head movements are mainly resulted from movement of the person's neck in three movement axes: (1) flexion/extension (along longitudinal direction of the person's body); (2) lateral flexion and (3) rotation. A neck extension will cause a person's head to pitch upwards while a neck flexion will cause a person's head to pitch downwards to his/her body along a vertical axis. Right and left neck lateral flexions will cause a person's head to roll and tilt around a frontal axis. Right and left neck rotations will cause a person's head around a vertical (yaw) axis.

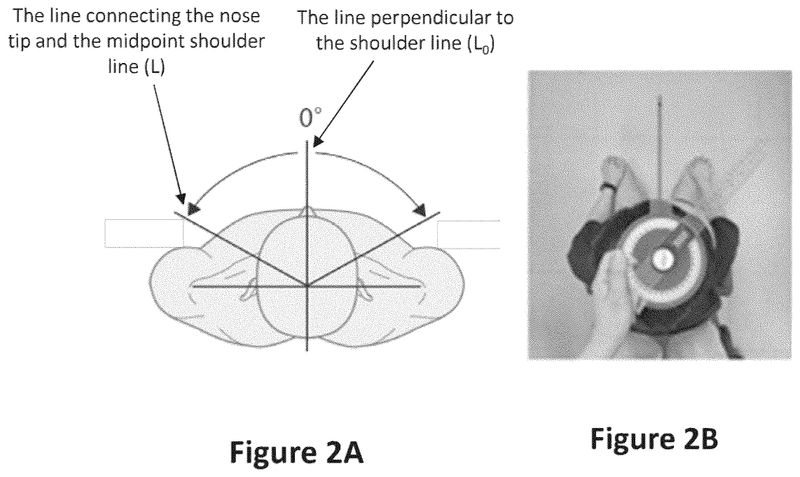

FIG. 2A shows a schematic diagram 200 illustrating a neck rotation angle measured from the top view of a person. The neck rotation angle refers to an angle of the head rotated around a reference point relative to a reference frontal line. The reference frontal line is the shoulder line of the person while the reference point is the midpoint of the shoulder line. The reference frontal line connects the reference point and the nose tip of the person and is set to 0° when it is perpendicular to reference frontal plane. A negative rotation angle corresponds to a left rotation while a positive rotation angle corresponds to a right rotation. In a clinal setting, neck (head) rotation angle is usually measured by a trained therapist with a goniometer, shown in FIG. 2B, from the top of the subject's head.

As mentioned earlier, most telemedicine settings only use a single camera to capture the subject's video or photo at a horizontal level, e.g., from the frontal or side view. From such frontal or side view, only neck flexion, flexion, right lateral flexion and left lateral flexion are easily measurable, while it is difficult to measure rotation.

There is a need for a method to measure head rotation angle using an image comprising a frontal view of a person to address the above issues in the field of telemedicine.

The present disclosure provides a system and method to estimate head rotation using the image of a person's frontal body, for example, comprising minimally the head and shoulder, based on certain known characteristics of human facial dimensions.

Such method and system, advantageously, requires only a single image comprising a frontal view of a person to estimate the head rotation angle of the person. A reference image of the neutral position is not required. In addition, only a small number of face and body landmarks are required therefore time taken to perform landmarks detection is reduced, and the method is computationally less expensive.

Also, the system and method can adaptively switch to use alternative facial landmarks and face landmark detectors in cases where certain landmarks do not have good visibility or confidence score of detection; and are agnostic to camera perspective distortion and no camera calibration is required. More details will be elaborated below.

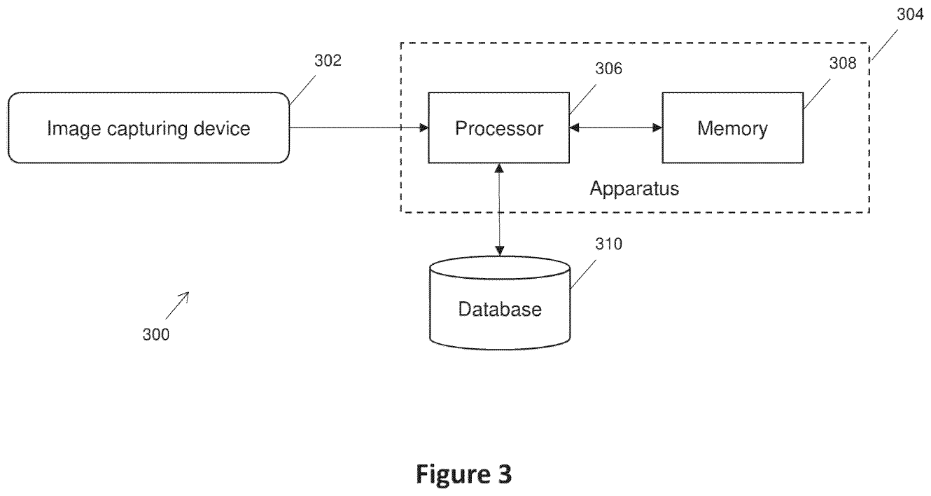

FIG. 3 shows a block diagram illustrating an apparatus 304 for estimating an angle of rotation of a head of a person from an image comprising a frontal view of the person according to various embodiments of the present disclosure.

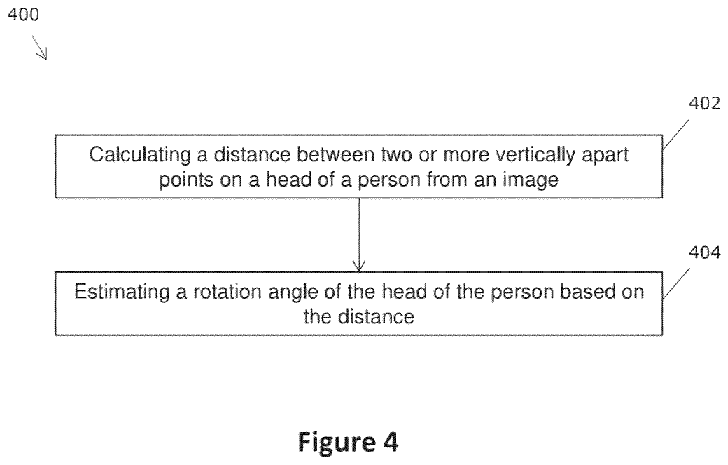

The managing of image or video input is performed by at least one image capturing device 302 and an apparatus 304. For the sake of simplicity, only one image capturing device 302 is illustrated. The system 300 comprises an image capturing device 302 in communication with the apparatus 304. In an implementation, the apparatus 304 may be generally described as a physical device comprising at least one processor 306 and at least one memory 308 including computer program code. The at least one memory 308 and the computer program code are configured to, with the at least one processor 306, cause the physical device to perform the operations described in FIG. 4. The processor 306 is configured to receive one or more images or videos from the image capturing device 302 or retrieve one or more images or videos from a database. Alternatively or additionally, the one or more images or videos captured by the image capturing device 302 is stored in a database 310, and the processor 306 is configured to retrieve the one or more images or videos from the database 310. It should be appreciated that the image capturing device 302 may be a part of the apparatus 304, forming a system 300 to perform operations described in FIG. 4.

The image capturing device 302 may be a device such as a mobile phone camera which provides a variety of data such as data relating to a facial and/or body feature and/or a movement of the facial and/or body feature of a person. In an implementation, appearance data derived from the video capturing device 302 may be stored in memory 308 of the apparatus 304 or a database 310 accessible by the apparatus 304. The data may include (i) facial and body feature data such as relative position, size, shape and/or contour of eyes, nose, cheekbones, jaw, chin, neck, shoulder, arm, and/or more particularly, jugular notch, shoulder centre, glabella, sellion, chin, supramentale, sellion, pronasale and subnasale, and also iris pattern, skin colour, hair colour or a combination thereof, (ii) physical characteristic data such as height, body size, body ratio, shoulder width, distance between two facial and body features, length of limbs, hair colour, skin colour, apparels, belongings, equipment, other similar characteristics or combinations, and (iii) behavioral characteristic data such as movement, position of limbs, position of apparel/belonging/equipment, direction of movement, differential in movement direction, moving speed, frequency, movement patterns, the way or the time period a person or his/her facial and body feature stay stills or moves, other similar characteristics or combinations.

In an implementation, camera data such as location and resolution, and/or time data which includes a timestamp at which the person or his/her facial or body feature is identified may also be derived from the image capturing device 302. The camera data and/or time data may be stored in memory 308 of the apparatus 304 or a database 310 accessible by the apparatus 304 and the processor 306 is configured to identify and retrieve data, image or video based on the time data. It should be appreciated that the database 310 may be a part of the apparatus 304.

The apparatus 304 may be configured to communicate with the image capturing device 302 and the database 310. In an example, the apparatus 304 may receive, from the image capturing device 302, or retrieve from the database 310, one or more images or videos of a monitoring area corresponding to a field of view of the image capturing device 302, within which a frontal view of a person is detected.

According to the present disclosure, the memory 308 and the computer program code stored therein are configured to, with the processor 306 cause the apparatus 304 to calculate a distance between two or more vertically apart points on a head of a person from an image comprising a frontal view of the person, and estimating a rotation angle of the head of the person based on the distance. The memory 308 and the computer program code stored therein are configured to, with the processor 306 cause the apparatus 304 to further calculate a rotation radius of the head based on the distance, wherein the rotation angle of the head is estimated based on the rotation radius.

In one embodiment, the memory 308 and the computer program code stored therein are configured to, with the processor 306 cause the apparatus 304 to further multiply the distance with a coefficient, wherein the coefficient ranges between 1.062-1.110, preferably 1.081, and calculate the rotation angle of the head is estimated based on a result of the multiplication.

In another embodiment, the memory 308 and the computer program code stored therein are configured to, with the processor 306 cause the apparatus 304 to further adjust the calculated radius based on an expected error in calculating the calculated rotation radius, and estimate the rotation angle of the head further based on the adjusted rotation radius.

In various embodiments of the present disclosure, to estimate the rotation angle of the head of the person using the image, the memory 308 and the computer program code stored therein are configured to, with the processor 306 cause the apparatus 304 to further calculate a horizontal displacement of one or more target points on the head from a vertical reference line across the head generated from the image, and estimate the rotation angle of the head further based on the horizontal displacement.

In one embodiment, the memory 308 and the computer program code stored therein are configured to, with the processor 306 cause the apparatus 304 to further detect a reference point on the head from the image, wherein a position of the reference point remains relatively unchanged from the frontal view regardless of the rotation angle of the head, and generate the vertical reference line cutting across the reference point on the head.

In another embodiment, the memory 308 and the computer program code stored therein are configured to, with the processor 306 cause the apparatus 304 to further detect two or more reference points on the head from the image, wherein each of the two or more reference points is associated with a first confidence score exceeding a first threshold confidence score, the first confidence score indicating a probability of the each of the two or more reference points being accurately detected and the first threshold confidence score indicating a threshold probability for determining that there is a high probability of the each of the two or more reference points being accurately detected; and select one of the two or more reference points with a highest first confidence score as the reference point.

Yet in another embodiment, the memory 308 and the computer program code stored therein are configured to, with the processor 306 cause the apparatus 304 to further detect the two or more vertically apart points and the one or more target points on the head from the image; determine whether each of the two or more vertically apart points and the one or more target points is associated with a second confidence score exceeding a second threshold confidence score, the second confidence score indicating a probability of the each of the two or more vertically apart points and the one or more target points being accurately detected and the second threshold confidence score indicating a minimum probability for determining that there is a high probability of the each of the two or more vertically apart points and the one or more target points being accurately detected; and estimate the rotation angle of the head further based on a result of determining that the second confidence score of the each of the two or more vertically apart points and the one or more target points is associated with exceeds the second threshold confidence score.

In one embodiment, the reference point comprises at least one of a jugular notch and a shoulder centre between two shoulders; one of the two or more vertically apart points comprises at least one of a glabella and a sellion, a chin and a supramentale; and the one or more target points comprises at least one of a sellion, a pronasale and a subnasale.

FIG. 4 shows a flow chart 400 illustrating a method for estimating a rotation angle of a head of a person according to various embodiments of the present disclosure. In step 402, a step of calculating a distance between two or more vertically apart points on a head of a person from an image is carried out. In step 404, a step of estimating a rotation angle of the head of the person is carried out based on the distance. In one embodiment, in step 402, a step of calculating a rotation radius of the head based on the distance is further carried out, and in step 404, the step of estimating the rotation angle is carried out further based on the rotation radius. In another embodiment, in step 402, a step of calculating a horizontal displacement of one or more target points on the head from a vertical reference line across the head generated from the image is further carried out, and in step 404, the step of estimating the rotation angle is carried out further based on the horizontal displacement.

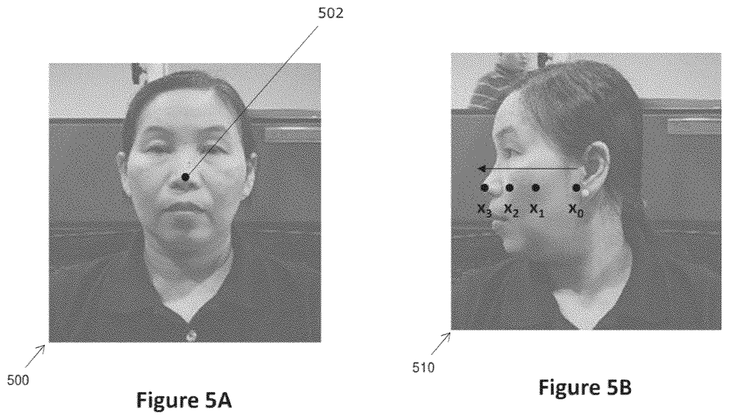

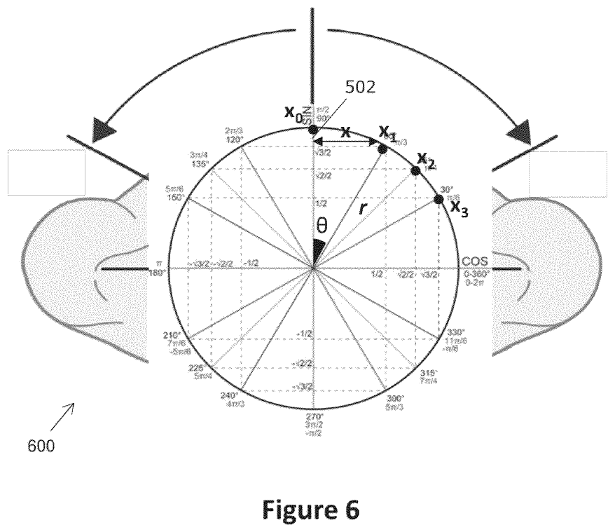

FIG. 5A shows an image 500 of a person's head in its neutral position from a frontal view perspective and FIG. 5B shows an image 510 of a person's head from the same frontal perspective view after the person performs a head rotation. FIG. 6 shows a schematic diagram 600 illustrating a radius of rotation and a horizontal displacement of a person's nose tip from the top view when the person performs a head rotation. During the head rotation, the person's nose tip 502 shifts horizontally from the frontal view perspective from x₀, x₁, x₂ to x₃. The angle of rotation 0 can be computed using the radius of rotation r (i.e., nose-tip-to-rotation-axis distance) and the horizontal displacement x of the nose tip. It is appreciated that a facial landmark other than the nose tip can be used to compute the angle of rotation A using equation (1).

$$sin θ = x / r \qquad equation ( 1 )$$

Conventionally, the radius of rotation r is measured from the top view. According to the present disclosure, it is noted that there may be some dimension of the frontal view which has strong correlation with the radius of rotation r, therefore the radius of rotation r can be measured from such dimension of the frontal view to enable head rotation angle estimation from a single frontal view image of a person.

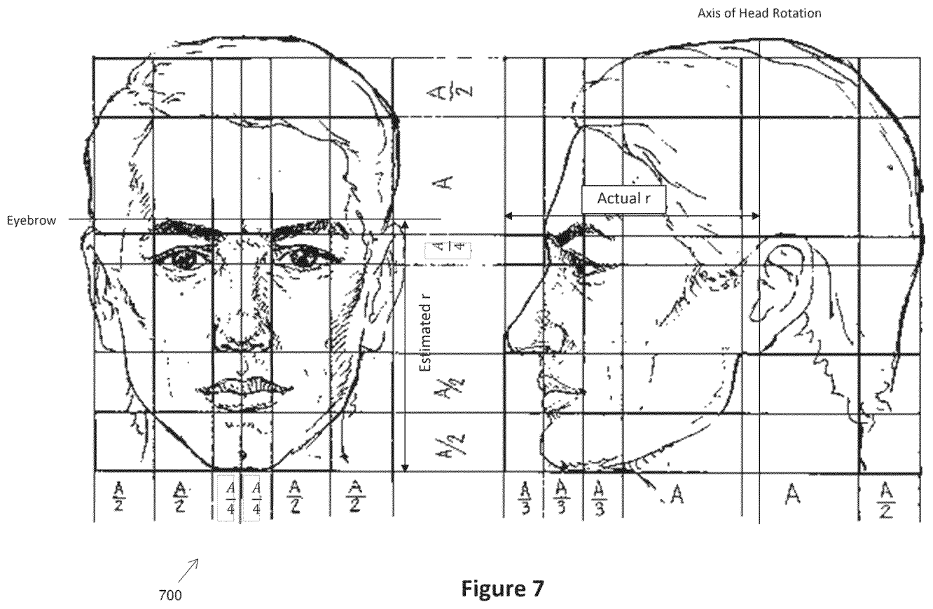

FIG. 7 shows a schematic diagram of a frontal view and a side view of a person. Conventionally, the actual radius of rotation r can be measured from the distance between the nose tip and the axis of head rotation. The axis of head rotation may be a shoulder centre or a midpoint of the shoulder line, as shown in FIG. 2A. According to the present disclosure, the radius of rotation r can be estimated from two vertically apart points/landmarks (hereinafter may be referred to landmark pair) on the face/head of the person from the frontal view. In one example, the distance between the nose tip and the rotation axis from the side view is approximately equal to or correlates to the distance between the top of the eyebrow and the chin from the frontal view, and therefore the distance between the top of the eyebrow and the chin from the frontal view can be used to estimate the actual radius of rotation r of the person.

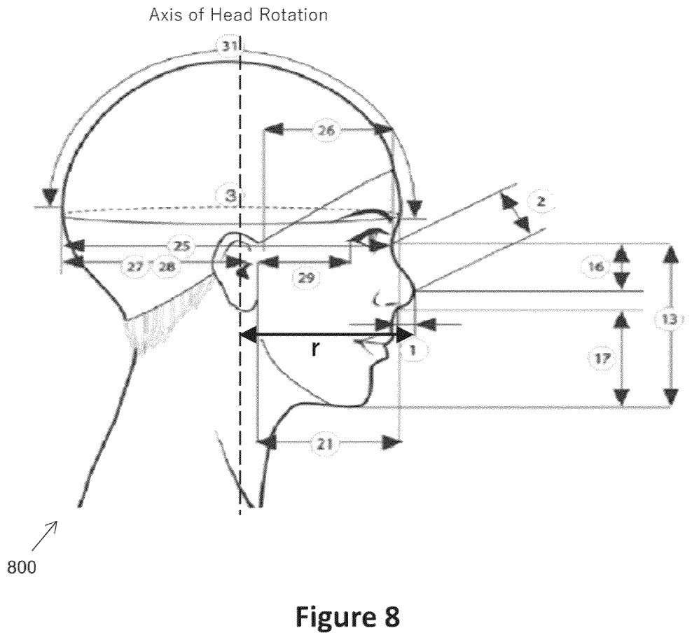

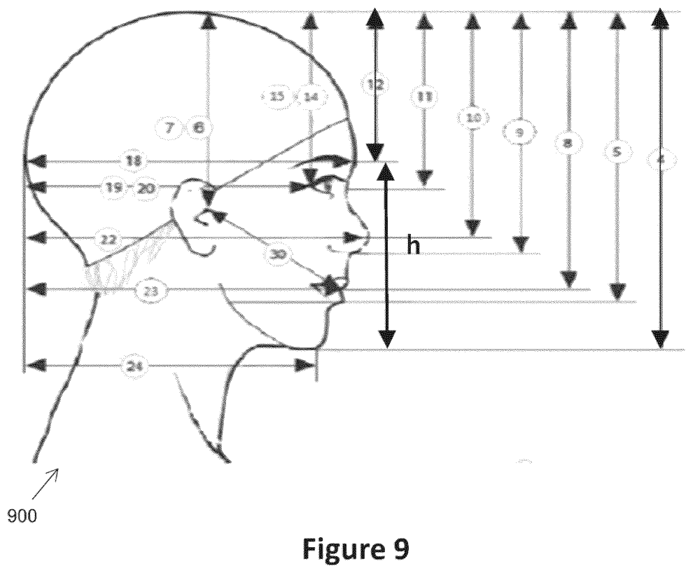

FIGS. 8 and 9 show schematic diagrams 800, 900 illustrating the various distances between two points on a person's head from a side view. As mentioned earlier, a radius of rotation r can be measured from the distance between the nose tip and the axis of head rotation. Alternatively, a radius of rotation r can be derived using measurements of distance #22 in FIG. 9 plus distance #1 in FIG. 8 minus distance #29 in FIG. 8.

According to the present disclosure, radius of rotation can be calculated based on the measurements of distance h from the frontal view, for example, based on the eyebrow-chin distance h or measurements of distance #4 minus distance #12 in FIG. 9. In one embodiment, the radius of rotation r can be calculated by multiplying the measurement of distance h from the frontal view with a coefficient k, as shown in equation (2).

$$r = kh \qquad equation ( 2 )$$

Normally, head sizes can be classified into three clusters using k-means cluster analysis, and it can be derived that k is 1.110, 1.071 and 1.062 in the three clusters, respectively. Therefore, k may be a number between a range of 1.0621.110. Alternatively, the means of the k in the three clusters, 1.081 is used to derive r from h.

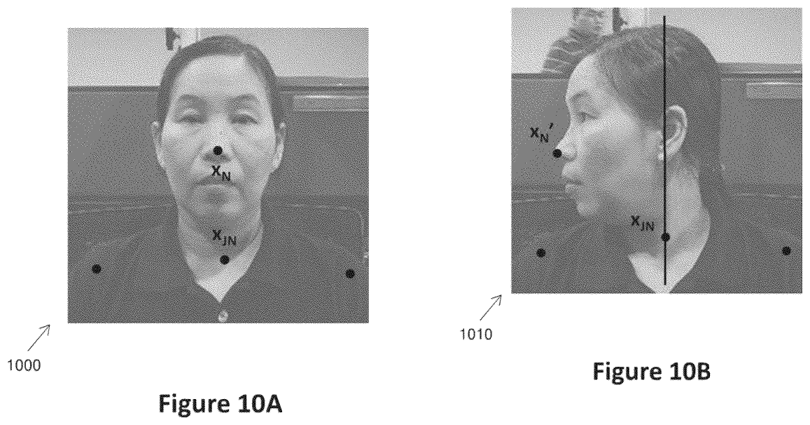

FIGS. 10A and 10B show a reference frame 1000 and a target frame 1010 comprising a frontal view of a person where the person's head is in neutral position and where the person's head is rotated out from its neutral position, respectively. Conventionally, the horizontal displacement x is obtained by measuring the displacement of a landmark such as nose tip from its original neutral position XN in the reference frame to its new position x′N in the target frame. According to the present disclosure, the horizontal displacement x (hereinafter referred to as “medial landmark displacement”) can be obtained without a reference frame and instead, by measuring the displacement of a landmark x′N such as nose tip from a vertical reference line drawn from a reference point such as jugular notch or shoulder centre XIN in the target frame.

Such method can result in the following advantages:
Taking a single image is sufficient, hence reducing processing time and power to enable real time measurement;
Eliminating the challenge to determine whether the person's head is at a neutral position, i.e., front-facing with 0 rotation;
Eliminating inaccuracy caused by any shift of person's body or the camera's position when taking two images to measure the rotation angle.

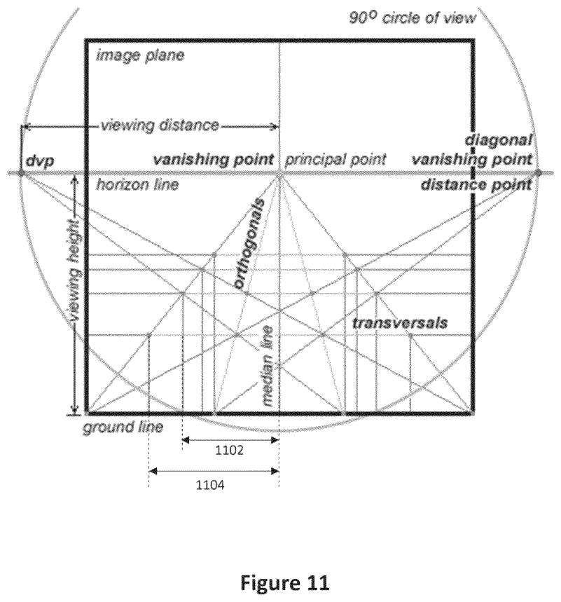

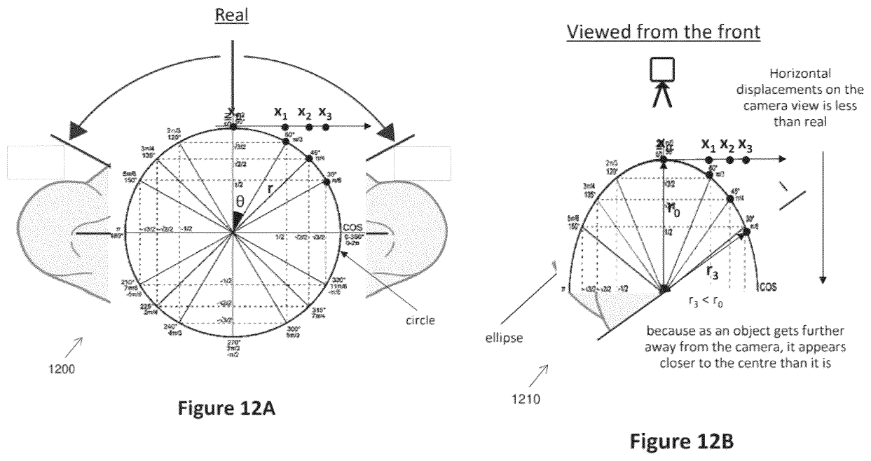

It is noted, there may be distortion in the horizontal displacement x due to the perspective changes as shown in FIG. 11. For example, the horizontal displacement x measured from frontal view 1102 is shorter than the horizontal displacement x measured from top view 1104 due to such perspective changes. In other words, the horizontal displacement x measured from top view is different from the horizontal displacement x measured from frontal view. FIGS. 12A and 12B show schematic diagrams 1200, 1210 illustrating a radius of rotation and a horizontal displacement of a person's nose tip measured from the top view and from the frontal view, respectively, when the person performs a head rotation. When viewing the nose tip of a rotated head from the frontal view, its position as seen on the image deviates from its real position as projected onto the horizontal axis. This is because the nose tip is moving away from the camera as the head rotates to the sides, so it appears closer to the centre than it actually is. In other words, the positions of x₃ viewed from top and front are different, and thus perceived displacement is less than actual due to perspective change. The rotation angle measured from frontal view when the head is rotated is also different from, and in fact smaller than, the rotation angle r or r₀ when measured from the top. Considering this, the path of nose tip movement appears to be an ellipse instead of a circle.

However, it is further noted that when calculating the distance h between two vertically apart points/landmarks (e.g., eyebrow-chin distance) to estimate r, the distance h is also subjected to the same distortion due to the same perspective change when the head is rotated to the sides.

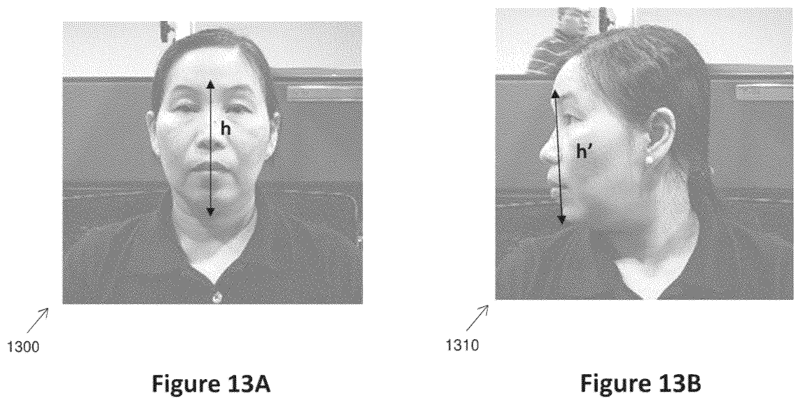

FIGS. 13A and 13B show two frontal view frames 1300, 1310 illustrating eyebrow-chin distances when the person's head is in neutral position and when the person's head is rotated, respectively. The eyebrow-chin distance is h at neutral position, whereas when the person's head is rotated to the sides, due to the perspective change, the positions of both chin and eyebrow as perceived from the image deviate and result in different eyebrow-chin distance h′, where h is less than h. The effects of reduction in the eyebrow-chin distance x and horizontal distortion h′ cancel out each other and so the eyebrow-chin distance h′ at the rotated view is still a god estimation of the angle of rotation r, using the following equation (3).

$$sin θ = x / r = x / kh = {x}^{’} / {kh}^{’} \qquad equation ( 3 )$$

where x is the real horizontal displacement of a target landmark (e.g., nose tip) with head rotation, x′ is the rotation displacement of a target landmark with head 19 rotation perceived from the frontal view, h is the real distance between two vertically apart landmarks (e.g., eyebrow and chin), h′ is the distance between the two vertically apart landmarks perceived from the frontal view, r is the radius of rotation and k is the coefficient used to convert h measured from frontal view to r. The coefficient k is 1.110, 1.071 and 1.062 for different head size clusters, or ranged between 1.062-1.110 or 1.081, which is the means of the three.

As a generalization, besides the nose tip, other landmarks along the facial medial line can be used to measure head rotation angle. Similarly, other body landmarks along the trunk medial line can be used as the invariant reference point. Also, besides eyebrow-chin, other facial landmark pairs can be used to estimate r.

It is appreciated that the use of x and x′ and h and h′ is to differentiate the horizontal displacement and the landmark pair distance measured from top view and frontal view. In examples where top view is not described, x and h can refer the horizontal displacement and the landmark pair distance measured/perceived from the frontal view and use to measure rotation radius r and angle θ.

Three different types of landmarks may be defined to calculate horizontal displacement and distance between a landmark pair:
Trunk medial landmark (TML) as any point on the frontal body trunk medial line. Typically, a TML remains relatively unchanged from the frontal view regardless of the rotation angle of the head, therefore, it is used as a reference point to draw a vertical medial reference line.
Facial medial landmark (FML) as any point on the frontal face medial line, Typically, a FML substantially changes its position from the frontal view when the head is rotated. It is thus used, in combination with TML, to calculate the horizontal displacement x when the head is rotated.
Facial landmark pair (FLP) as two different points on the frontal face view for calculating distance h.

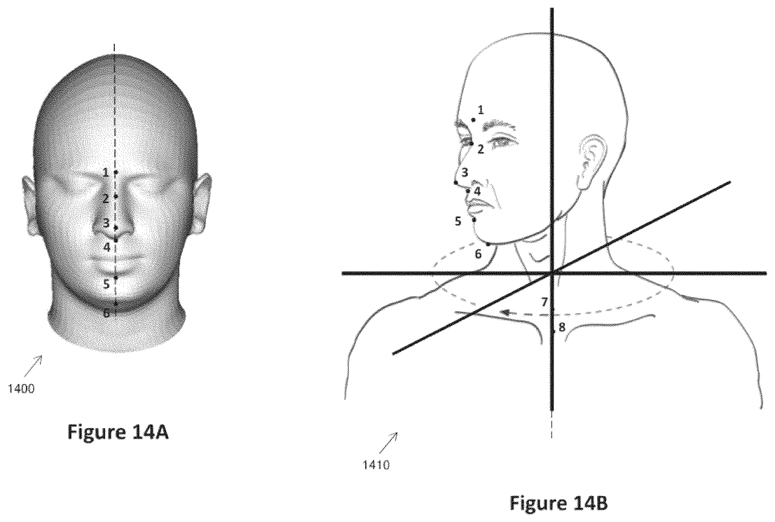

The system pre-defines a set of landmarks to be included as TML, FML and FLP candidates for head rotation angle estimation. Landmarks which are more easily detected with high confidence level of accuracy (hereinafter may be referred to as confidence score) are used as candidates. A confidence level of accuracy is one of the attributes of a detected landmark, indicating a probability of the detected landmark being accurately detected by the landmark detector(s). The confidence score of a landmark depends on multiple factors such as clarity of the image, posture, clothing, brightness and occlusion, etc. In one example, the confidence score is an output from a landmark detector, for example, using past detection, results and open source engines such as Google MediaPipe, OpenCV. A set of landmarks which have confidence levels of accuracy higher than a threshold confidence level of accuracy (or threshold confidence score) will be set as candidates for head rotation angle estimation. FIGS. 14A and 14B show 3D models 1400, 1410 illustrating example TMLs, FMLs and FLPs according to an embodiment of the present disclosure. Table 1 shows a list of landmarks to be detected and their corresponding numerical annotations in FIGS. 14A and 14B. For example, jugular notch (#7) and/or shoulder centre (#8) can be used as TML candidates; sellion (#2), pronasale (#3) and/or subnasale (#4) can be used as FML candidates; glabella-chin (#1, #5), sellion-chin and (#2, #5) glabella-supramentale (#1, #5) can be used as FLP candidates.

TABLE 1

| # | Landmarks |
|---|---|
| 1 | Glabella |
| 2 | Sellion |
| 3 | Pronasale |
| 4 | Subnasale |
| 5 | Supramentale |
| 6 | Chin |
| 7 | Jugular Notch |
| 8 | Shoulder |

Table 2 shows example measurements of a distance h using FLPs in FIGS. 14A and 14B (or their equivalents in FIGS. 8 and 9) for three different head size clusters.

TABLE 2

| FLP | Cluster 1 | Cluster 2 | Cluster 3 |
|---|---|---|---|
| #1, #5 (#5 − [symbol] | 83.9 | 84.0 | 88.2 |
| #2, #6 (#13) | 90.3 | 104.0 | 120.2 |
| #1, #6 (#4 − [symbol] | 105.4 | 111.6 | 114.6 |

[symbol]

indicates data missing or illegible when filed

Table 3 shows example measurements of a horizontal displacement x from rotation axis using TML and FML in FIGS. 14A and 14B (or their equivalents in FIGS. 8 and 9) for three different head size clusters.

TABLE 3

| FLP | Cluster 1 | Cluster 2 | Cluster |
|---|---|---|---|
| #2 (#21) | 83.7 | 93.1 | 114.5 |
| #3 (#22 + #1 − [symbol] | 117.0 | 119.5 | 121.7 |
| #4 (#22 − #28) | 109.7 | 108.8 | 108.4 |

[symbol]

indicates data missing or illegible when filed

Table 4 shows an example r/h ratio matrix using the measurements in Tables 2 and 3 for three different head size clusters.

TABLE 4

| | | Cluster 1 | | | Cluster 2 | | | Cluster 3 | | |
|---|---|---|---|---|---|---|---|---|---|---|
| | | FLP | | | FLP | | | FLP | | |
| | | 1, 5 | 2, 6 | 1, 6 | 1, 5 | 2, 6 | 1, 6 | 1, 5 | 2, 6 | 1, 6 |
| FML | 2 | 0.998 | 0.924 | 0.794 | 1.108 | 0.895 | 0.834 | 1.298 | 0.953 | 0.999 |
| | 3 | 1.395 | 1.291 | 1.110 | 1.423 | 1.149 | 1.071 | 1.380 | 1.012 | 1.062 |
| | 4 | 1.308 | 1.211 | 1.041 | 1.295 | 1.046 | 0.975 | 1.229 | 0.902 | 0.946 |

Table 5 shows the means and standard deviation, in parenthesis, of r/h ratio across all clusters. [symbol] minimum standard deviation of ratios indicating that the ratio of (Glabella-Supramentale distance) to (Pronasale-Rotation Axis distance) is rather similar among people. It relates to human face anthropometry. Hence, they are the preferred FLP and FML for head rotation angle estimation. The 9 combinations of FLP-FML can be ranked (in square brackets) in the order of preference by ascending standard deviations.

In one embodiment, noting that the mean full head rotation is about 55.8° and the difference in r/h ratio between clusters are less than 2%, a 3% error is expected in estimating the rotation radius r. An adjustment to the calculated rotation radius may be made before estimating the rotation angle θ of the head. At about 55.8°, ±3% error in r corresponds to error in rotation angle θ less than ±3. For the same rate of error in r, the error in rotation angle θ decreases as the rotation angle decreases.

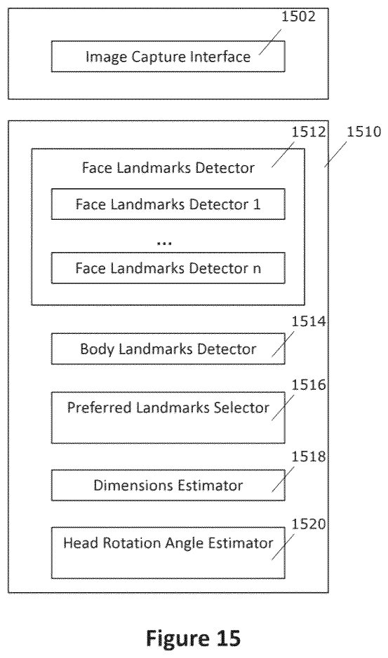

FIG. 15 shows a block diagram 1500 illustrating an apparatus 1510 for estimating an angle of rotation of a head of a person from an image comprising a frontal view of the person according to various embodiment of the present disclosure. The apparatus 1510 may comprises a face landmarks detector 1512, a body landmarks detector 1514, a preferred landmarks selector 1516, a dimensions estimator 1514 and a head rotation angle estimator 1520. The apparatus 1510 may be in connection with an image capture interface 1502 configured to receive an image of the person from an image capturing apparatus (not shown) or retrieves an existing image from a database (not shown). The face landmarks detector 1512 receives the image from 1502 and is configured to select one of the face landmarks detectors to detect face landmarks with confidence scores. The face landmarks detector 1512 may comprise multiple face landmarks detectors 1-n. The face landmarks detectors 1-n may be ranked by a preference which is based on several factors such as required computational resource, computation speed and accuracy.

The body landmarks detector 1514 receives the image from the image capture interface 1502 and is configured to detect trunk medial landmarks. The preferred landmarks selector 1516 receives output from the face landmark detector 1512 and is configured to select a combination of medial landmark and landmark pair, along with the respective coefficient k. The dimensions estimator 1518 receives output from the body landmarks detector 1514 and the preferred landmarks selector 1516 and is configured to computes the medial landmark (horizontal) displacement x and landmark pair distance h.

The head rotation angle estimator 1520 receives output from the dimensions estimator 1518 and is configured to estimate the head rotation angle as sin^{-1x}/kh′.

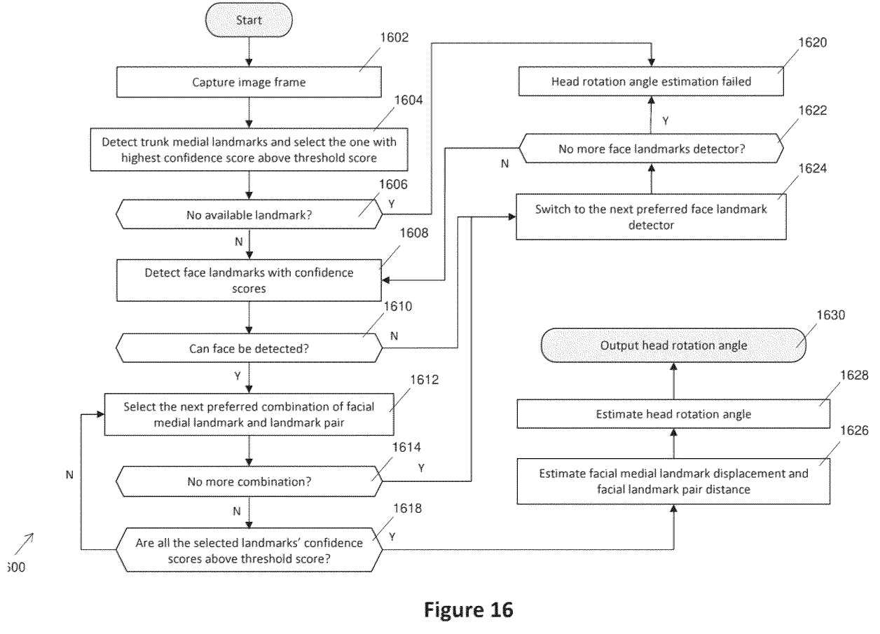

FIG. 16 shows a flow chart 1600 illustrating an example process for estimating an angle of rotation of a head of a person from an image comprising a frontal view of the person according to an embodiment of the present disclosure. In step 1602, an image frame is captured. In step 1604, a step of detecting trunk medial landmarks and selecting the one with highest confidence score above a threshold confidence score is carried out. In step 1606, it is determined if there is no available trunk medial landmark. If there is available trunk medial landmark, step 1608 is carried out; otherwise, step 1620 is carried out to show that head rotation angle estimation failed. In step 1608, a step of detecting face landmarks with confidence scores is carried out. In step 1610, it is determined whether the person's face can be detected. If the face can be detected, step 1612 is carried out; otherwise step 1624 is carried out. In step 1612, a step of selecting the next preferred combination of facial medial landmark and landmark pair is carried out. In step 1614, it is determined whether there is no more combination of facial medial landmark and landmark pair. If there is no more combination, step 1618 is carried out; otherwise step 1624 is carried out.

In step 1624, a step of switching to the next preferred face landmark detector is carried out. In step 1622, it is determined if there is no more face landmark detector, for example which is specialized to detect certain facial landmark. If there is no more face landmark detector, step 1620 is carried out to show that head rotation angle estimation failed. If there is at least one more face landmark detector, the next preferred face landmark detector switched in step 1624 will then be used to perform step 1608.

In step 1618, it is determined whether all the selected landmarks' confidence scores are above threshold. If all the selected landmarks' confidence scores are above the threshold score, the process return to step 1612. If all the selected landmarks' confidence scores are above the threshold sore, step 1626 is carried out.

In step 1626, a step of estimating facial medial landmark displacement and facial landmark pair distance is carried out. In step 1628, a step of estimating a head rotation angle is carried out. In step 1630, the head rotation angle is then output.

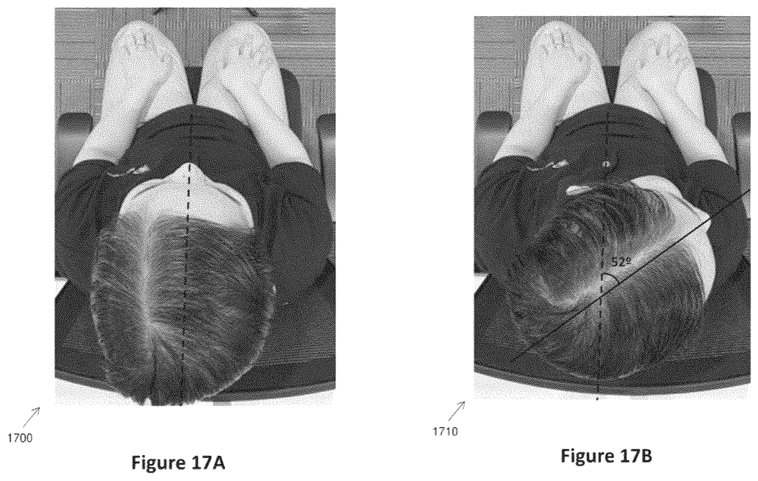

FIGS. 17A and 17B show first example reference frame 1700 and target frame 1710 used in conventional method for estimating a head rotation angle from the top view. The reference frame 1700 is necessary with the person facing forward at the neutral position to draw a reference line, for example, connecting the nose tip and the midpoint shoulder line. The reference line is set as 0° rotation and used to measure the subsequent head angle rotation angle in the target frame 1710. In this case, a 52° rotation is measured.

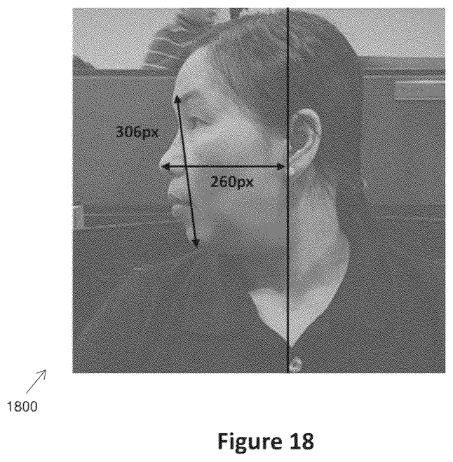

On the other hand, FIG. 18 shows a first example single frame 1800 used for estimating a head rotation angle from the frontal view according to an embodiment of the present disclosure. From this image 1800, a TML such as jugular notch or shoulder centre can be detected and used as a reference point to draw a vertical reference line, and a FML such as nose trip is then detected. A horizontal displacement of the FML from the vertical reference line caused by the head rotation is calculated or derived based on the number of pixels of the FML from the vertical reference line. In addition, a FLP such as eyebrow and chin is detected and the distance between the FLP is calculated or derived based on the number of pixels between the FLP. In this case), x spans 260 pixels and h spans 306 pixels of the image 1800. Using equation (3) where k is 1.081 (median), a rotation angle θ of 51.8° is estimated. This result produced by the new method is comparable to the one measured from the top view using a reference image.

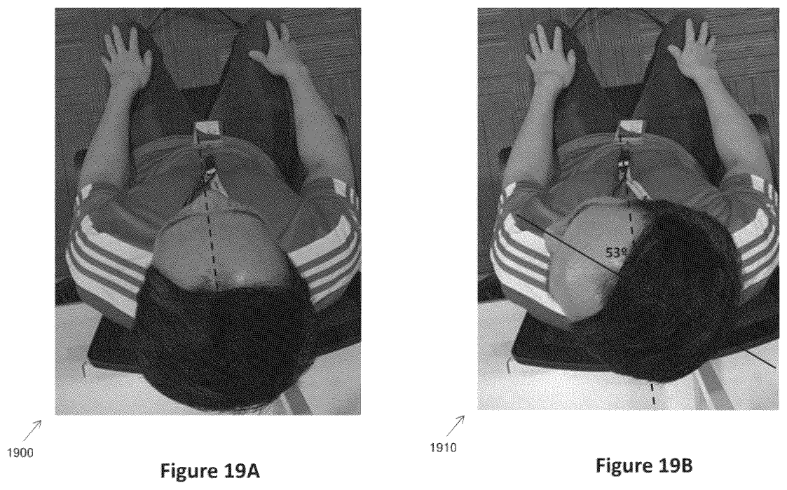

FIGS. 19A and 19B show second example reference frame 1900 and target frame 1910 used in conventional method for estimating a head rotation angle from the top view. The reference frame 1900 is necessary with the person facing forward at the neutral position to draw a reference line, for example, connecting the nose tip and the midpoint shoulder line. The reference line is set as 0° rotation and used to measure the subsequent head angle rotation angle in the target frame 1910. In this case, a 53° rotation is measured.

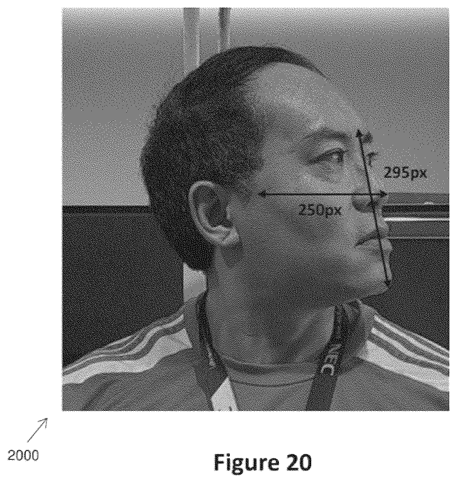

On the other hand, FIG. 20 shows a second example single frame 2000 used for estimating a head rotation angle from the frontal view according to an embodiment of the present disclosure. In this case, x spans 250 pixels and h spans 295 pixels. Using equation (3) where k is 1.081 (median), a rotation angle θ of 51.6° is estimated. This result produced by the new method is comparable to the one measured from the top view using a reference image.

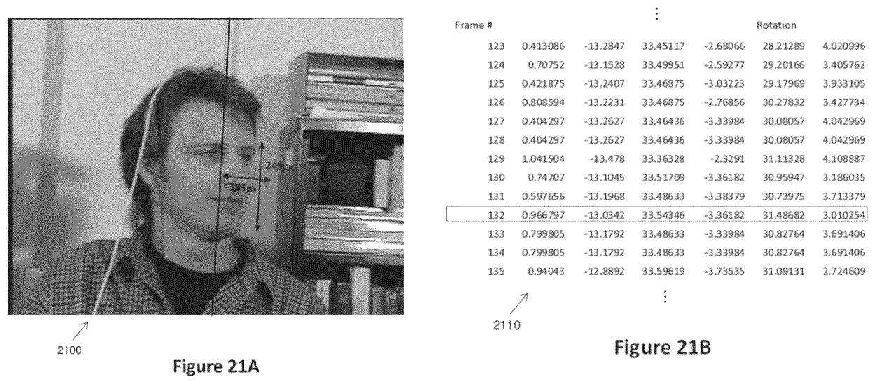

The accuracy of the result produced by the head rotation angle estimation method according to the present disclosure is comparable to that produced a motion sensor. FIG. 21A shows the 132^{th} frame 2100 of a 200-frame video comprising a frontal view of a person performing a head rotation and FIG. 21B shows a table 2110 with the rotation angle results measured by a motion sensor at the time when the 123^{th}-135^{th} frames of the 200-frame video referred to in FIG. 21A were taken. In particular, 200 frames of the person performing the head rotation were taken from the frontal view while the person was wearing a 6-DOF motion sensor, and the results estimated by the method of the present disclosure and motion sensor are compared. Using the head rotation angle estimation method according to the present disclosure, the horizontal displacement x from a vertical reference line spans 135 pixels and landmark pair distance h spans 245 pixels in FIG. 21A. Using equation (3) where k is 1.081 (median), a rotation angle 6 of 30.7° is estimated. This result produced by the new head rotation angle estimation method according to the present disclosure is comparable to the result (31.48682°) measured by the motion sensor.

As mentioned earlier, according to the present disclosure, the head rotation angle measurement only requires one image to complete. No reference frame is required for setting up the system for the measurement as the system is easy to implement and can start the rotation angle measurement from the first frame till last frame of the video. This can also enable estimation and tracking of the head rotation in real time.

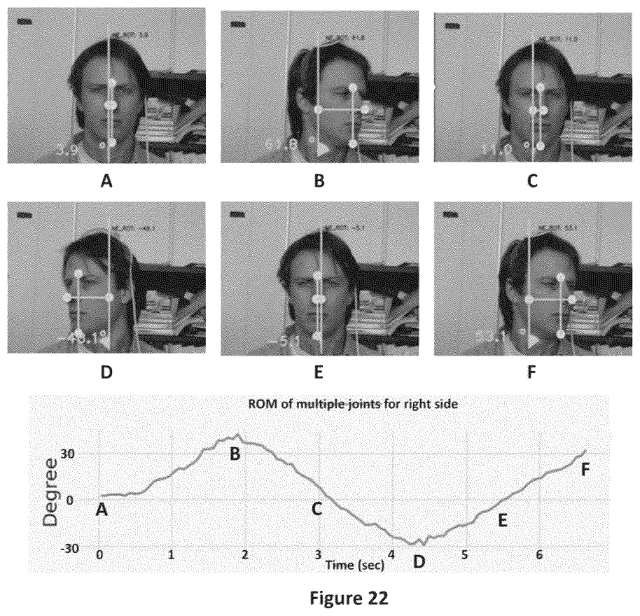

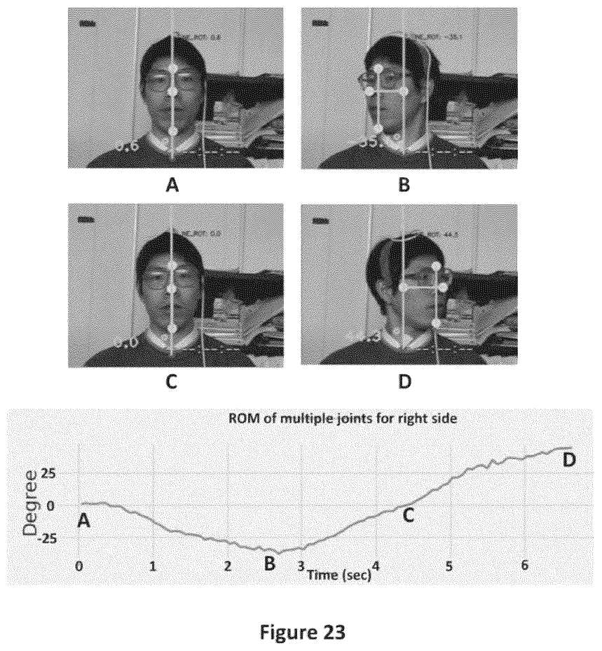

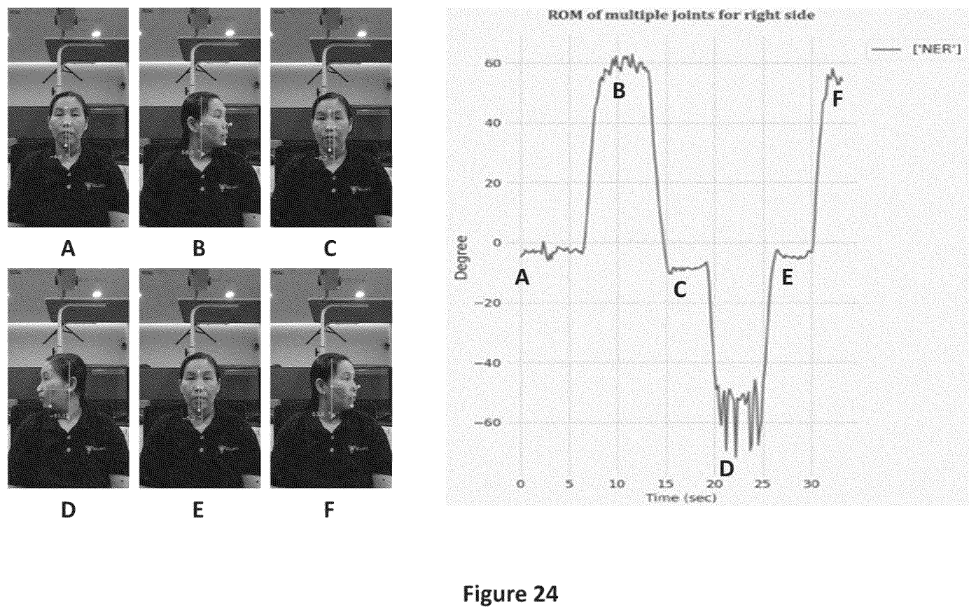

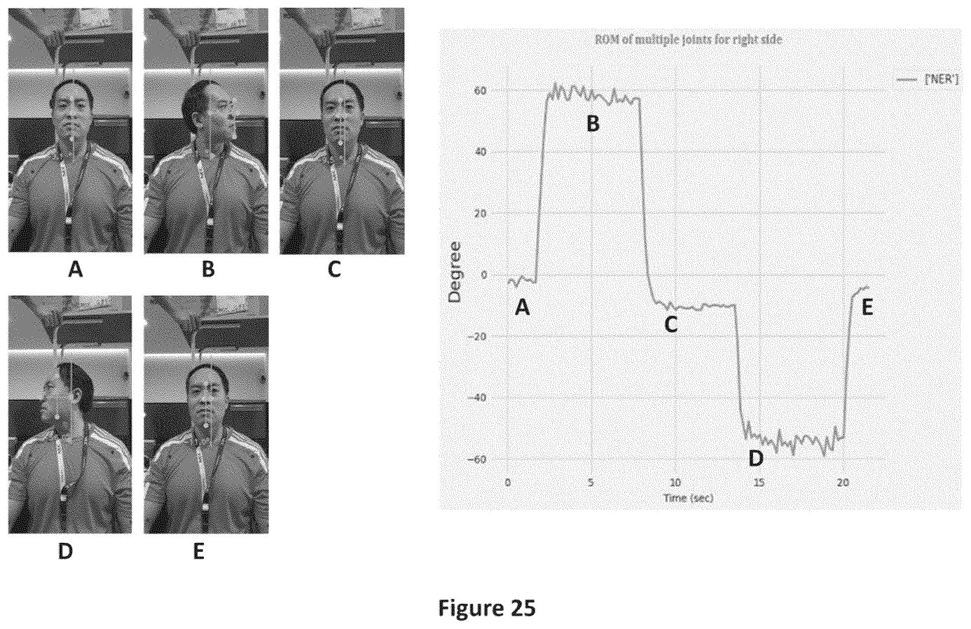

FIGS. 22-25 show four different examples of implementing a system for estimating a person's head rotation angle from a video comprising a frontal view of the person according to various embodiments of the present disclosure. The videos may be obtained in real time or retrieved from a database. In particular, the head movements and rotations of a person are detected, measured and tracked at every frame from frame A to frame F in FIGS. 22 and 24, frame A to frame D in FIG. 23 and frame A to frame E in FIG. 25, therefore a graph of a range of movement (ROM) of multiple joints for right side showing each person's head rotation angle tracking results is generated.

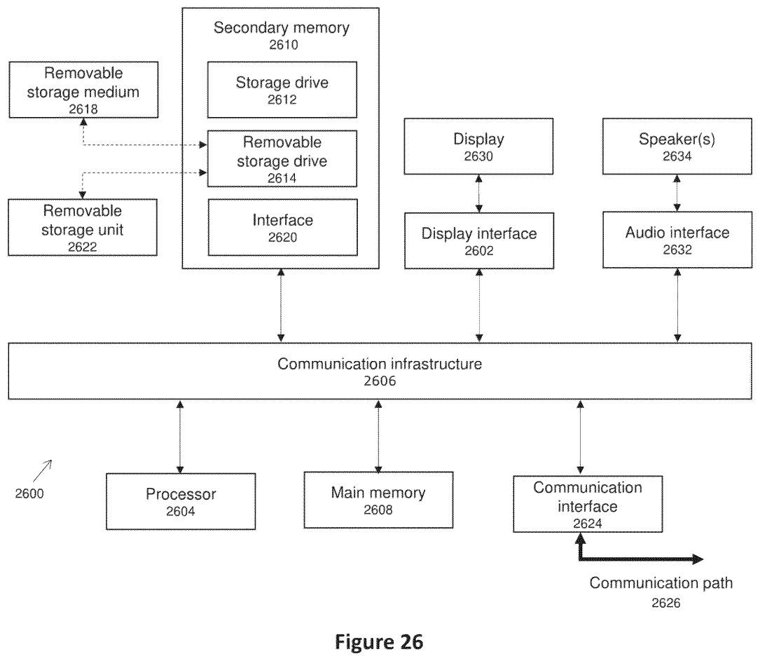

FIG. 26 depicts an exemplary computing device 2600, hereinafter interchangeably referred to as a computer system 2600, where one or more such computing devices 2600 may be used to execute the method of FIG. 4. The exemplary computing device 2600 can be used to implement the apparatus 300 shown in FIG. 3. The following description of the computing device 2600 is provided by way of example only and is not intended to be limiting.

As shown in FIG. 26, the example computing device 2600 includes a processor 2604 for executing software routines. Although a single processor is shown for the sake of clarity, the computing device 2600 may also include a multiprocessor system. The processor 2604 is connected to a communication infrastructure 2606 for communication with other components of the computing device 2600. The communication infrastructure 2606 may include, for example, a communications bus, cross-bar, or network.

The computing device 2600 further includes a main memory 2608, such as a random access memory (RAM), and a secondary memory 2610. The secondary memory 2610 may include, for example, a storage drive 2612, which may be a hard disk drive, a solid state drive or a hybrid drive and/or a removable storage drive 2614, which may include a magnetic tape drive, an optical disk drive, a solid state storage drive (such as a USB flash drive, a flash memory device, a solid state drive or a memory card), or the like. The removable storage drive 2614 reads from and/or writes to a removable storage medium 2618 in a well-known manner. The removable storage medium 2618 may include magnetic tape, optical disk, non-volatile memory storage medium, or the like, which is read by and written to by removable storage drive 2614. As will be appreciated by persons skilled in the relevant art(s), the removable storage medium 2618 includes a computer readable storage medium having stored therein computer executable program code instructions and/or data.

In an alternative implementation, the secondary memory 2610 may additionally or alternatively include other similar means for allowing computer programs or other instructions to be loaded into the computing device 2600. Such means can include, for example, a removable storage unit 2622 and an interface 2260. Examples of a removable storage unit 2622 and interface 2260 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 2622 and interfaces 2260 which allow software and data to be transferred from the removable storage unit 2622 to the computer system 2600.

The computing device 2600 also includes at least one communication interface 2624. The communication interface 2624 allows software and data to be transferred between computing device 2600 and external devices via a communication path 2626. In various embodiments of the inventions, the communication interface 2624 permits data to be transferred between the computing device 2600 and a data communication network, such as a public data or private data communication network. The communication interface 2624 may be used to exchange data between different computing devices 600 which such computing devices 2600 form part an interconnected computer network. Examples of a communication interface 2624 can include a modem, a network interface (such as an Ethernet card), a communication port (such as a serial, parallel, printer, GPIB, IEEE 1394, RJ45, USB), an antenna with associated circuitry and the like. The communication interface 2624 may be wired or may be wireless. Software and data transferred via the communication interface 2624 are in the form of signals which can be electronic, electromagnetic, optical or other signals capable of being received by communication interface 2624. These signals are provided to the communication interface via the communication path 2626.

As shown in FIG. 22, the computing device 2600 further includes a display interface 2602 which performs operations for rendering images to an associated display 2230 and an audio interface 2232 for performing operations for playing audio content via associated speaker(s) 2234.

As used herein, the term “computer program product” may refer, in part, to removable storage medium 2618, removable storage unit 2622, a hard disk installed in storage drive 2612, or a carrier wave carrying software over communication path 2626 (wireless link or cable) to communication interface 2624. Computer readable storage media refers to any non-transitory, non-volatile tangible storage medium that provides recorded instructions and/or data to the computing device 2600 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 2600. Examples of transitory or non-tangible computer readable transmission media that may also participate in the provision of software, application programs, instructions and/or data to the computing device 2600 include radio or infra-red transmission channels as well as a network connection to another computer or networked device, and the Internet or Intranets including e-mail transmissions and information recorded on Websites and the like.

The computer programs (also called computer program code) are stored in main memory 2608 and/or secondary memory 2610. Computer programs can also be received via the communication interface 2624. Such computer programs, when executed, enable the computing device 2600 to perform one or more features of embodiments discussed herein. In various embodiments, the computer programs, when executed, enable the processor 1207 to perform features of the above-described embodiments. Accordingly, such computer programs represent controllers of the computer system 2600.

Software may be stored in a computer program product and loaded into the computing device 2600 using the removable storage drive 2614, the storage drive 2612, or the interface 2260. The computer program product may be a non-transitory computer readable medium. Alternatively, the computer program product may be downloaded to the computer system 2600 over the communications path 2626. The software, when executed by the processor 2604, causes the computing device 2600 to perform the necessary operations to execute the method as shown in FIG. 4.

It is to be understood that the embodiment of FIG. 22 is presented merely by way of example to explain the operation and structure of the apparatus 200. Therefore, in some embodiments one or more features of the computing device 2600 may be omitted. Also, in some embodiments, one or more features of the computing device 2600 may be combined together. Additionally, in some embodiments, one or more features of the computing device 2600 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the above-described embodiments can be combined as desirable by one of ordinary skill in the art.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

While the disclosure has been particularly shown and described with reference to exemplary embodiments thereof, the disclosure is not limited to these embodiments. It will be understood by those of ordinary skill in the art that various changes in form and details may be made therein without departing from the spirit and scope of the present disclosure as defined by the claims.

The whole or part of the exemplary embodiments disclosed above can be described as, but not limited to, the following supplementary notes.

### (Supplementary Note 1)

A method for estimating a rotation angle of a head of a person using an image comprising a frontal view of the person, the method comprising:
calculating a distance between two or more vertically apart points on the head of the person from the image; and
estimating a rotation angle of the head of the person based on the distance.

### (Supplementary Note 2)

The method of supplementary note 1, further comprising: calculating a rotation radius of the head based on the distance, wherein the rotation angle of the head is estimated based on the rotation radius.

### (Supplementary Note 3)

The method of supplementary note 2, wherein the calculating the rotation radius of the head based on the distance comprises:
multiplying the distance with a coefficient, wherein the coefficient ranges between 1.062-1.110, wherein the rotation angle of the head is estimated based on a result of the multiplication.

### (Supplementary Note 4)

The method of supplementary note 3, wherein the coefficient is 1.081.

### (Supplementary Note 5)

The method of any one of supplementary notes 2-4, further comprising:
adjusting the calculated rotation radius based on an expected error in calculating the calculated rotation radius, wherein the rotation angle of the head is estimated further based on the adjusted rotation radius.

### (Supplementary Note 6)

The method of any one of supplementary notes 1-5, further comprising:
calculating a horizontal displacement of one or more target points on the head from a vertical reference line across the head generated from the image; and
estimating the rotation angle of the head further based on the horizontal displacement.

### (Supplementary Note 7)

The method of supplementary note 6, further comprising:
detecting a reference point of the person from the image, wherein a position of the reference point remains relatively unchanged from the frontal view regardless of the rotation angle of the head; and
generating the vertical reference line cutting across the reference point.

### (Supplementary Note 8)

The method of supplementary note 7, wherein the detecting the reference point of the person from the image comprises:
detecting two or more reference points of the person from the image, wherein each of the two or more reference points is associated with a first confidence score exceeding a first threshold confidence score, the first confidence score indicating a probability of the each of the two or more reference points being accurately detected and the first threshold confidence score indicating a threshold probability for determining that there is a high probability of the each of the two or more reference points being accurately detected; the method further comprising:
selecting one of the two or more reference points with a highest first confidence score as the reference point.

### (Supplementary Note 9)

The method of supplementary note 7 or 8, wherein the reference point comprises at least one of a jugular notch and a shoulder centre between two shoulders.

### (Supplementary Note 10)

The method of any one of supplementary notes 6-9, further comprising:
detecting the two or more vertically apart points and the one or more target points on the head from the image;
determining whether each of the two or more vertically apart points and the one or more target points is associated with a second confidence score exceeding a second threshold confidence score, the second confidence score indicating a probability of the each of the two or more vertically apart points and the one or more target points being accurately detected and the second threshold confidence score indicating a minimum probability for determining that there is a high probability of the each of the two or more vertically apart points and the one or more target points being accurately detected;
wherein the estimating the rotation angle of the head is further based on a result of determining that the second confidence score of the each of the two or more vertically apart points and the one or more target points is associated with exceeds the second threshold confidence score.

### (Supplementary Note 11)

The method of any one of supplementary notes 1-10, wherein one of the two or more vertically apart points comprises at least one of a glabella and a sellion, a chin and a supramentale; and the one or more target points comprises at least one of a sellion, a pronasale and a subnasale.

### (Supplementary Note 12)

An apparatus for estimating a rotation angle of a head of a person using an image comprising a frontal view of the person, the apparatus comprising:
at least one processor; and
at least one memory including computer program code;
the at least one memory and the computer program code configured to, with at least one processor, cause the apparatus at least to:
calculate a distance between two or more vertically apart points on the head of the person from the image; and
estimate a rotation angle of the head of the person based on the distance.

### (Supplementary Note 13)

The apparatus of supplementary note 12, the at least one memory and the computer program code configured to, with at least one processor, cause the apparatus at least to:
calculate a rotation radius of the head based on the distance, wherein the rotation angle of the head is estimated further based on the rotation radius.

### (Supplementary Note 14)

The apparatus of supplementary note 13, the at least one memory and the computer program code configured to, with at least one processor, cause the apparatus at least to:
multiplying the distance with a coefficient, wherein the coefficient ranges between 1.062-1.110; and
calculate the rotation radius of the head based on a result of the multiplication.

### (Supplementary Note 15)

The apparatus of supplementary note 14, wherein the coefficient is 1.081.

### (Supplementary Note 16)

The apparatus of any one of supplementary notes 13-15, the at least one memory and the computer program code configured to, with at least one processor, cause the apparatus at least to:
adjust the calculated rotation radius based on an expected error in calculating the calculated rotation radius; and
estimate the rotation angle of the head further based on the adjusted rotation radius.

### (Supplementary Note 17)

The apparatus of any one of supplementary notes 12-16, the at least one memory and the computer program code configured to, with at least one processor, cause the apparatus at least to:
calculate a horizontal displacement of one or more target points on the head from a vertical reference line across the head generated from the image; and
estimating the rotation angle of the head based on the horizontal displacement.

### (Supplementary Note 18)

The apparatus of supplementary note 17, the at least one memory and the computer program code configured to, with at least one processor, cause the apparatus at least to:
detect a reference point of the person from the image, wherein a position of the reference point remains relatively unchanged from the frontal view regardless of the rotation angle of the head; and
generate the vertical reference line cutting across the reference point of the person.

### (Supplementary Note 19)

The apparatus of supplementary note 18, the at least one memory and the computer program code configured to, with at least one processor, cause the apparatus at least to:
detect two or more reference points of the person from the image, wherein each of the two or more reference points is associated with a first confidence score exceeding a first threshold confidence score, the first confidence score indicating a probability of the each of the two or more reference points being accurately detected and the first threshold confidence score indicating a threshold probability for determining that there is a high probability of the each of the two or more reference points being accurately detected; and
select one of the two or more reference points with a highest first confidence score as the reference point.

### (Supplementary Note 20)

The apparatus of supplementary note 18 or 19, wherein the reference point comprises at least one of a jugular notch and a shoulder centre between two shoulders.

### (Supplementary Note 21)

The apparatus of any one of supplementary notes 17-20, the at least one memory and the computer program code configured to, with at least one processor, cause the apparatus at least to:
detect the two or more vertically apart points and the one or more target points on the head from the image;
determine whether each of the two or more vertically apart points and the one or more target points is associated with a second confidence score exceeding a second threshold confidence score, the second confidence score indicating a probability of the each of the two or more vertically apart points and the one or more target points being accurately detected and the second threshold confidence score indicating a minimum probability for determining that there is a high probability of the each of the two or more vertically apart points and the one or more target points being accurately detected; and
estimate the rotation angle of the head further based on a result of determining that the second confidence score of the each of the two or more vertically apart points and the one or more target points is associated with exceeds the second threshold confidence score.

### (Supplementary Note 22)

The apparatus of any one of supplementary notes 12-21, wherein one of the two or more vertically apart points comprises at least one of a glabella and a sellion, a chin and a supramentale; and the one or more target points comprises at least one of a sellion, a pronasale and a subnasale.

### (Supplementary Note 23)

A system for estimating a rotation angle of a head of a person using an image comprising a frontal view of the person, the system comprises the apparatus of any one of supplementary notes 12-22 and an image capturing apparatus for capturing the image comprising the frontal view of the person.

1. A method for estimating a rotation angle of a head of a person using an image comprising a frontal view of the person, the method comprising:
calculating a distance between two or more vertically apart points on the head of the person from the image; and
estimating a rotation angle of the head of the person based on the distance.

2. The method of claim 1, further comprising:
calculating a rotation radius of the head based on the distance, wherein the rotation angle of the head is estimated based on the rotation radius.

3. The method of claim 2, wherein the calculating the rotation radius of the head based on the distance comprises:
multiplying the distance with a coefficient, wherein the coefficient ranges between 1.062-1.110, wherein the rotation angle of the head is estimated based on a result of the multiplication.

4. The method of claim 3, wherein the coefficient is 1.081.

5. The method of claim 2, further comprising:
adjusting the calculated rotation radius based on an expected error in calculating the calculated rotation radius, wherein the rotation angle of the head is estimated further based on the adjusted rotation radius.

6. The method of claim 1, further comprising:
calculating a horizontal displacement of one or more target points on the head from a vertical reference line across the head generated from the image; and
estimating the rotation angle of the head further based on the horizontal displacement.

7. The method of claim 6, further comprising:
detecting a reference point of the person from the image, wherein a position of the reference point remains relatively unchanged from the frontal view regardless of the rotation angle of the head; and
generating the vertical reference line cutting across the reference point.

8. The method of claim 7, wherein the detecting the reference point of the person from the image comprises:
detecting two or more reference points of the person from the image, wherein each of the two or more reference points is associated with a first confidence score exceeding a first threshold confidence score, the first confidence score indicating a probability of the each of the two or more reference points being accurately detected and the first threshold confidence score indicating a threshold probability for determining that there is a high probability of the each of the two or more reference points being accurately detected; the method further comprising:
selecting one of the two or more reference points with a highest first confidence score as the reference point.

9. The method of claim 7, wherein the reference point comprises at least one of a jugular notch and a shoulder centre between two shoulders.

10. The method of claim 6, further comprising:
detecting the two or more vertically apart points and the one or more target points on the head from the image;
determining whether each of the two or more vertically apart points and the one or more target points is associated with a second confidence score exceeding a second threshold confidence score, the second confidence score indicating a probability of the each of the two or more vertically apart points and the one or more target points being accurately detected and the second threshold confidence score indicating a minimum probability for determining that there is a high probability of the each of the two or more vertically apart points and the one or more target points being accurately detected;
wherein the estimating the rotation angle of the head is further based on a result of determining that the second confidence score of the each of the two or more vertically apart points and the one or more target points is associated with exceeds the second threshold confidence score.

11. The method of claim 1, wherein one of the two or more vertically apart points comprises at least one of a glabella and a sellion, a chin and a supramentale; and the one or more target points comprises at least one of a sellion, a pronasale and a subnasale.

12. An apparatus for estimating a rotation angle of a head of a person using an image comprising a frontal view of the person, the apparatus comprising:
at least one processor; and
at least one memory including computer program code;
the at least one memory and the computer program code configured to, with at least one processor, cause the apparatus at least to:
calculate a distance between two or more vertically apart points on the head of the person from the image; and
estimate a rotation angle of the head of the person based on the distance.

13. The apparatus of claim 12, the at least one memory and the computer program code configured to, with at least one processor, cause the apparatus at least to:
calculate a rotation radius of the head based on the distance, wherein the rotation angle of the head is estimated further based on the rotation radius.

14. The apparatus of claim 13, the at least one memory and the computer program code configured to, with at least one processor, cause the apparatus at least to:
multiplying the distance with a coefficient, wherein the coefficient ranges between 1.062-1.110; and
calculate the rotation radius of the head based on a result of the multiplication.

15. The apparatus of claim 14, wherein the coefficient is 1.081.

16. The apparatus of claim 13, the at least one memory and the computer program code configured to, with at least one processor, cause the apparatus at least to:
adjust the calculated rotation radius based on an expected error in calculating the calculated rotation radius; and
estimate the rotation angle of the head further based on the adjusted rotation radius.

17. The apparatus of claim 12, the at least one memory and the computer program code configured to, with at least one processor, cause the apparatus at least to:
calculate a horizontal displacement of one or more target points on the head from a vertical reference line across the head generated from the image; and
estimating the rotation angle of the head based on the horizontal displacement.

18. The apparatus of claim 17, the at least one memory and the computer program code configured to, with at least one processor, cause the apparatus at least to:
detect a reference point of the person from the image, wherein a position of the reference point remains relatively unchanged from the frontal view regardless of the rotation angle of the head; and
generate the vertical reference line cutting across the reference point of the person.

19. The apparatus of claim 18, the at least one memory and the computer program code configured to, with at least one processor, cause the apparatus at least to:
detect two or more reference points of the person from the image, wherein each of the two or more reference points is associated with a first confidence score exceeding a first threshold confidence score, the first confidence score indicating a probability of the each of the two or more reference points being accurately detected and the first threshold confidence score indicating a threshold probability for determining that there is a high probability of the each of the two or more reference points being accurately detected; and
select one of the two or more reference points with a highest first
confidence score as the reference point.

20. The apparatus of claim 18, wherein the reference point comprises at least one of a jugular notch and a shoulder centre between two shoulders.
